(19) United States
(12) Patent Application Publication
(10) Pub. No.: US 2013/0015714 A1
(43) Pub. Date: Jan. 17, 2013

(54) Smart Power Portal

(71) Applicant: Leo Y. Kwok, Milpitas, CA (US)

(72) Inventor: Leo Y. Kwok, Milpitas, CA (US)

(21) Appl. No.: 13/184,106

(22) Filed: Jul. 15, 2011

(51) Int. Cl. H02M 7/02; H02J 1/00

(52) U.S. Cl. 307/75

(57) ABSTRACT

A smart power portal able to supply electrical power to attached or connected electronic or electrical devices is disclosed. The portal, which can be a power strip or wall-mounted unit, includes a receiver, a transformer, a direct current (“DC”) converter, and a Greeny port. The receiver, in one embodiment, is coupled to an alternating current (“AC”) power source for drawing electricity of AC power, and the transformer is able to convert at least a portion of the AC power to DC power. The DC converter is able to convert the DC power into a grade of DC voltage levels, and the Greeny port is coupled with a removable electronic device. The portal, in one aspect, includes multiple outlets wherein each outlet provides an independent or specific voltage level of DC power output. The Greeny port, in one example, is capable of detecting minimal power required to operate the removable electronic device.

### FIELD

The exemplary embodiment(s) of the present invention relates to relates to power supply. More specifically, the exemplary embodiment(s) of the present invention relates to alternating current (“AC”) power and direct current (“DC”) power supply.

### BACKGROUND

A conventional power supply for providing electricity to AC powered and DC powered devices, such as medical instruments, commercial electronics, or mobiles, generally provides power with one specific characteristic to such devices with typically one or two form factors or common connecting platforms. The power supply can be in a form of an AC power extender, wall-mounted outlet having an AC-to-DC transformer, power strip, portal power supply apparatus, and the like. The common form factors typically involve different sizes of plugs and sockets such as conventional power plug and USB power cord. A problem associated with a conventional power supply is that it only provides one(1) types of power or power level with one type of form factor.

A television set, for example, typically acquires electrical power through a power cord connected to a power source via a wall-mounted socket or a power extender. For a conventional television set to operate, it requires AC power input having 110-120 volts (“V”) at 60 hertz (“Hz”) or with 220-240V at 50 Hz depending on the geographical locations. In addition, different connectors, coupling apparatus, or form factors may be used for television sets and/or commercial electronics requiring DC power supply.

A typical mobile phone, for instance, requires a DC power supply to recharge its internal rechargeable battery for device operating. Since majority of conventional power source over a wall-mounted, extender power supply, or power strip provides AC power, a type of conversion device such as a transformer may be used to convert from AC to DC power before any DC powered devices can operate. In addition, most power outlets (AC or DC) are individually powered without master-slave or power saving controls.

To operate multiple electronic devices having different voltage requirements such as 1.5V and 3.2V, users typically need to bring multiple adapters or transformers containing traditional AC-to-DC conversion capabilities outputting different voltage levels. Different adapters providing different voltage or current outputs have unique configurations of form factors. As such, a device may not be able to operate if its adapter is lost or missing. Also, carrying multiple adapters for different devices can be heavy and bulky.

### SUMMARY

A Smart Power Portal able to supply electrical power to attached or connected electronic or electrical devices is disclosed. The portal, which can be a power strip or wall-mounted unit, includes a receiver, a transformer, a direct current (“DC”) converter, and a Greeny port. The receiver, in one embodiment, is coupled to an alternating current (“AC”) power source for drawing electricity of AC power, and the transformer is able to convert at least a portion of the AC power to DC power. The DC converter is able to convert the DC power into a grade of DC voltage levels, and the Greeny port is coupled with a removable electronic device. The Greeny port, in one example, is capable of detecting minimal power required to operate the removable electronic device.

Additional features and benefits of the exemplary embodiment(s) of the present invention will become apparent from the detailed description, figures and claims set forth below.

### BRIEF DESCRIPTION OF THE DRAWINGS

Exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 illustrates AC power sockets or power plugs of different geographical regions with three (3) terminals in accordance with one embodiment of the present invention;

FIG. 2 illustrates AC power sockets or power plugs of different geographical regions with two (2) terminals in accordance with one embodiment of the present invention;

FIG. 3 illustrates a power extender powered by AC power source with several AC power outlets in accordance with one embodiment of the present invention;

FIG. 4 illustrates a wall-mounted power outlet with several power outlets in accordance with one embodiment of the present invention;

FIG. 5 illustrates a power extender or power strip having AC-to-DC transformer(s) providing power to multiple connected electronic devices in accordance with one embodiment of the present invention;

FIG. 6 illustrates a wall-mounted power outlet having AC-to-DC transformer(s) providing power to multiple connected electronic devices in accordance with one embodiment of the present invention;

FIG. 7 illustrates a Smart Power Extender powered having AC and DC power outlets in accordance with one embodiment of the present invention;

FIG. 8 is a circuit block diagram illustrating circuitry inside of Smart Power Extender able to provide AC and DC power in accordance with one embodiment of the present invention;

FIG. 9 illustrates a Smart Power Extender connected to AC power source and DC power source in accordance with one embodiment of the present invention;

FIG. 10 is a circuit block diagram illustrating circuitry inside of Smart Power Extender in accordance with one embodiment of the present invention;

FIG. 11 illustrates a Smart Wall-mounted Power powered by an internal AC power source in accordance with one embodiment of the present invention;

FIG. 12 is a circuit block diagram illustrating circuitry of a Smart Wall-mounted Power powered by an internal AC power source in accordance with one embodiment of the present invention;

FIG. 13 is a circuit block diagram illustrating components of a Smart Wall-mounted Power powered by internal AC power source and DC power source via structural electrical wiring system in accordance with one embodiment of the present invention;

FIG. 14 illustrates a Smart Wall-mounted Power with external DC power source and internal AC power source via electrical wiring system in accordance with one embodiment of the present invention;

FIG. 15 is a circuit block diagram illustrating circuitry inside of Smart Wall-mounted Power having a power selector in accordance with one embodiment of the present invention;

FIG. 16 illustrates a Smart Power Portal having a universal serial bus (“USB”) form factor in accordance with one embodiment of the present invention;

FIG. 17 illustrates a Greeny Port capable of coupling external to Smart Power Portal having an embedded means of Power Requirement Identification (“PRI”) in accordance with one embodiment of the present invention; and

FIG. 18 is a circuit block diagram illustrating components inside of Smart Power Portal having a control unit in accordance with one embodiment of the present invention.

### DETAILED DESCRIPTION

Exemplary embodiment(s) of the present invention is described herein in the context of a method, system and apparatus of supplying electricity with a grade of multiple power levels including AC and DC powers.

Those of ordinary skills in the art will realize that the following detailed description of the exemplary embodiment(s) is illustrative only and is not intended to be in any way limiting. Other embodiments will readily suggest themselves to such skilled persons having the benefit of this disclosure. Reference will now be made in detail to implementations of the exemplary embodiment(s) as illustrated in the accompanying drawings. The same reference indicators will be used throughout the drawings and the following detailed description to refer to the same or like parts.

References to “one embodiment,” “an embodiment,” “example embodiment,” “various embodiments,” “exemplary embodiment,” “one aspect,” “an aspect,” “exemplary aspect,” “various aspects,” et cetera, indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the interest of clarity, not all of the routine features of the implementations described herein are shown and described. It will, of course, be understood that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of this disclosure.

In accordance with the embodiment of present invention, the components, process steps, and/or data structures described herein may be implemented using various types of operating systems, computing platforms, computer programs, and/or general purpose machines. In addition, those of ordinary skills in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method including a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

A Smart Power Portal is capable of supplying electrical power to attached or connected electronic or electrical devices. The portal, which can be a power extender, a power strip or wall-mounted unit, includes a receiver, a transformer, a direct current (“DC”) converter, and a Greeny port. The receiver, in one embodiment, is coupled to an alternating current (“AC”) power source for drawing electricity of AC power, and the transformer is able to convert at least a portion of the AC power to DC power. The DC converter is able to convert the DC power into a grade of DC voltage levels, and the Greeny port is coupled with a removable electronic device. The Greeny port, in one example, is capable of detecting minimal power required to operate the removable electronic device.

Smart Power Portal, in one aspect, includes Smart Power Extender or Smart Wall-mounted Power, wherein Smart Power Portal can be incorporated in electrical wiring system for a structure such as a home or an office building. Smart Power Portal devices can reduce or eliminate the need of requiring multiple power adapters for multiple portable electrical/electronic devices. Another advantage of using Smart Power Portal can improve overall efficiency for power consumption.

Reference will now be made in detail to the embodiments of the present invention, the Smart Power Portal. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims.

The Smart Power Extender (“SPE”), which is one form of Smart Power Portal, includes an AC power supply input port wherein AC power is received from an AC power source via the AC power supply input port. In an alternative embodiment, the Smart Power Extender includes a DC power input port wherein DC power is received from DC power source through the DC power supply input port. AC power outlets are used to provide AC power to devices that require AC power to operation. The SPE further includes multiple AC power outlets and/or DC power outlets. DC power outlets are used to provide DC power to devices that require DC power to operation.

In one embodiment, AC power outlets of the SPE are configured to share or distribute AC power received from the AC power supply input port to various AC power outlets. It should be noted that the AC power outlets can be configured to be able to switch on or off by control signal (or switch) controlled by the user. Alternatively, one or more AC power outlets can be switch on/off by a switching signal which could be electrical, radio, or optical signal. The switching signal may be managed or controlled by the user.

The SPE, in one aspect, provides DC power through its DC power outlets capable of connecting to one or more external devices which require DC power to operate. If power supply input port of SPE receives AC power, the AC power is internally converted from AC to DC by an embedded AD-to-DC transformer (or converter) and the converted DC power is subsequently distributed to the DC power outlets. If power supply input port receives DC power, the DC power may be internally divided into several different voltage levels by an embedded DC-to-DC converter with automated voltage and/or current regulation, and the DC power is subsequently distributed to the DC power outlets.

The DC power outlets of the SPE, in one embodiment, supply adjustable DC power based on predetermined or interactive power requirements. When the DC power supply input port does not receive DC power supply, the DC power outlets in the Smart Power Extender receive power from the embedded AC-to-DC transformer through the AC power supply input port. Depending on the applications, specific voltage levels of DC power outlets are determined by an embedded AC-to-DC transformer as well as embedded DC-to-DC converter. The Smart Power Portal further includes an intelligent power saving controller capable of conserving power consumption based upon requirements received from one or more external identifiers which can either be predetermined or interactive manners, such as wireless radio signals, Bluetooth™ signals, optical signals, et cetera.

In an alternative embodiment, when the DC power supply input port of SPE is connected to an external DC power supply source, the DC power outlets of SPE receive power from an embedded DC-to-DC converter which converts and/or divide DC power inputted from the DC power supply input port into multiple voltage levels. The voltage level of DC power received at the DC power supply input port is usually, but not necessary, greater than the voltage level(s) of DC power provided by the DC power outlets of SPE. When required or calibrated voltage level provided by the DC power outlets of SPE is the same as the voltage level of DC power received by the DC power supply input port of SPE, DC to DC conversion, in one aspect, is not necessary and a regulator is used to monitor the power transition. Depending on the applications, specifics of exact voltage level provided by the DC power outlets will be determined by the embedded DC-to-DC converter and/or the voltage level of DC power supply.

The Smart Wall-mounted Power (“SWP”), in one embodiment, is another form of the Smart Power Portal and is able to receive power via a port(s) either from AC power supply or DC power supply through existing home and/or office electric wiring system. The SWP provides the same or similar functions/features as the SPE except that the SWP is fixed while SPE can be portable. Electrical power delivered to home and/or office is generally supplied by a power station via power lines, wherein the power station can be a facility generating and storing power, such as coal generator, nuclear power station, hydro generator, Solar panels, renewable green power generators, power grid at regional power and utility companies, and the like.

Power from solar panels and/or renewable green power generators is, in one example, in a form of DC (or possibly AC) power which is routed and delivered to homes and/or office builds through electrical wiring using one or more the SWP outlets. In one embodiment, the SWP is configured to address, distribute, and route AC power from AC power source to AC power outlets of SWP. Similarly, the SWP is able to route DC power from DC power source to DC power outlets of SWP face plate. When the input power source is AC power only, the SWP employs the similar methods as SPE having embedded AC-to-DC transformer to supply or provide DC power to DC power outlets. An advantage of using the SWP is that it can be installed in a traditional home or office using AC power source to deliver multiple voltage levels of DC power as well as AC power.

In the case where a particular DC power outlet is plugged in with a DC power required device that utilizes a mean of providing PRI, Greeny Port of Smart Power Portal receives, senses, and/or reads the PRI from device and delivers proper voltage and/or current with specific characteristics based on the PRI. Greeny Port, in one embodiment, is configured to identify a requested voltage level in response to the PRI via external protocols/mechanisms. It should be noted that externally defined power requirement protocols can be provided through an external hardware with a protocol which can be either proprietary or IEEE standards defined by means of digital, electrical, or radio frequency signaling. The mechanisms of enquiring power requirement information are implementation specifics. The PRIs are supported by Greeny Ports of Smart Power Portal power.

The PRI mechanism, in one embodiment, resides external to the Smart Power Portal and can be embedded in a connector or cable which connects to Greeny Port of Smart Power Portal. The identification, for example, can be in the forms of electrical switches, electrically defined and/or digitally stored information. The stored information can be subsequently retrieved and processed by the Smart Power Portal for the purpose of determining DC power level or voltage level to a device connected to Greeny Ports.

The PRI includes power information including required voltage and current to operate a particular device. In an alternative embodiment, the PRI includes information other than required voltage and current, such as vendor ID and flags indicating status or behaviors of connected device(s). The composition and utilization of such flags are implementation specifics and they can be various for different applications.

The Smart Power Portal, in one embodiment, includes a chip containing processing controller, communication circuitry, memory and has capabilities to support power requirements from standard protocols. By employing processor or processing functions, the Smart Power Portal is capable to controlling one or more sockets of SWP, such as alarming, on/off switching, port grouping, and/or other intelligent functionalities. It should be noted that SPE may also include processors and communication circuitry to dynamically or statically manage and control power conversion as well as power conservation.

An advantage of employing the Smart Power Portal is to create and/or provide an environmental friendly, energy efficient, adaptability, and cost effective method(s) to deliver power to electrical/electronic devices using AC and DC power with several different voltage levels. The Smart Power Portal with Greeny Power outlets is applicable to homes, offices, as well as airplanes, ships, and trains.

The following detailed description of embodiment(s) of present invention, numerous specific details are set forth in order to provide a thorough understanding of the Smart Power Portal. However, it will be recognized by one of ordinary skill in the art that the embodiment(s) of present invention may be practiced without these specific details. In other instances, well known methods, procedures, components, and circuits have not been described in detail as not to unnecessarily obscure aspects of the present invention.

FIG. 1 illustrates AC power sockets or power plugs of different geographical regions with three (3) terminals in accordance with one embodiment of the present invention. While socket 100 is configured to receive a plug having three (3) square-shaped terminals 102-106, socket 120 is able to receive a plug having a combination of square-shaped and round-shaped terminals. Socket 140 is configured to receive a plug having three (3) round-shaped terminals 102-106 and socket 160 is able to receive a plug having three (3) squared-shaped terminals with an angle. Three (3) terminals 102-106 of AC power sockets or power plugs of different geographical regions are also referred to as Live, Neutral, and Earth, or hot, neutral, and ground. FIG. 1 shows typical AC power sockets or power plugs used at different geographical regions.

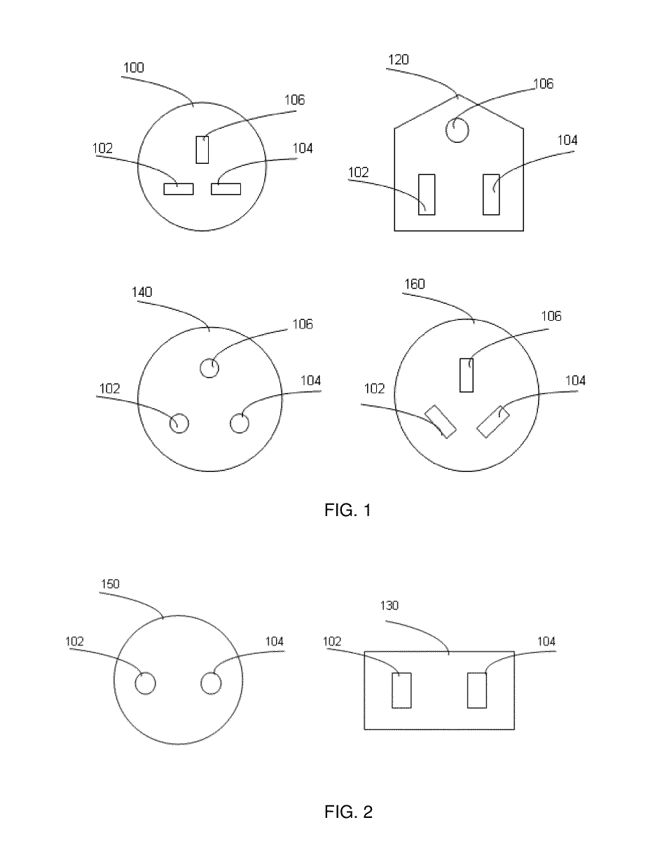

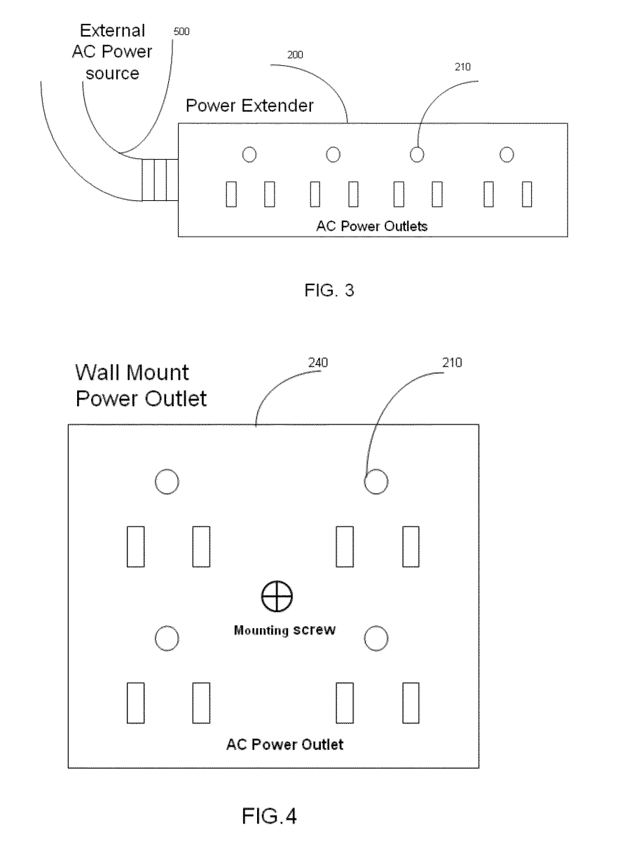

FIG. 2 illustrates AC power sockets or power plugs of different geographical regions with two (2) terminals in accordance with one embodiment of the present invention. AC power sockets or power plugs having two (2) terminals used in different geographical regions have only Live and Neutral terminal without the Earth terminals. FIG. 3 illustrates a power extender 200 powered by AC power source 500 with several AC power outlets 210 in accordance with one embodiment of the present invention. Power extender 200 is able to receive AC power from external AC power source 500 via a cable or wire, and subsequently distributes the received AC power to AC power outlets 210.

FIG. 4 illustrates a wall-mounted power outlet 240 with several power outlets 210 in accordance with one embodiment of the present invention. In one example, wall-mounted power outlet 240 includes four (4) sockets 210. The outlet with several power sockets are readily to be used by internal and/or external AC powered devices.

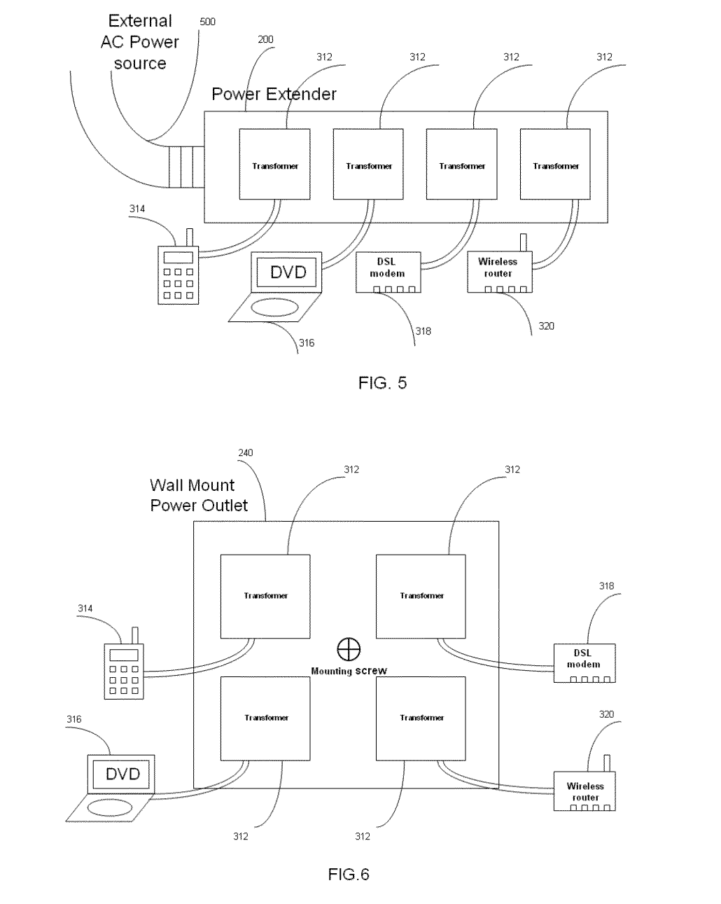

FIG. 5 illustrates a power extender or power strip having AC-to-DC transformer(s) providing power to multiple connected electronic devices in accordance with one embodiment of the present invention. Connections of AC-to-DC transformers 312 are shown through a power extender 200 powering electronic devices 314-320. In one embodiment, power extender which is also referred to SPE draws AC power from AC power source 500 and delivers power to a smart phone 314, a DVD player 316, a DSL modem 318, and a wireless router 320.

FIG. 6 illustrates a wall-mounted power outlet 240 having AC-to-DC transformer(s) providing power to multiple connected electronic devices in accordance with one embodiment of the present invention. Connections between AC-to-DC transformers 312 of wall-mounted power 240 and devices 314-320 are illustrated. In one embodiment, wall-mounted power 240, also known as SWP, is configured to provide AC or DC voltages to attached or plugged devices. For example, while wireless router 320 may acquire AC power from wall-mounted power outlet, smart phone 314 draws DC current from outlet 240.

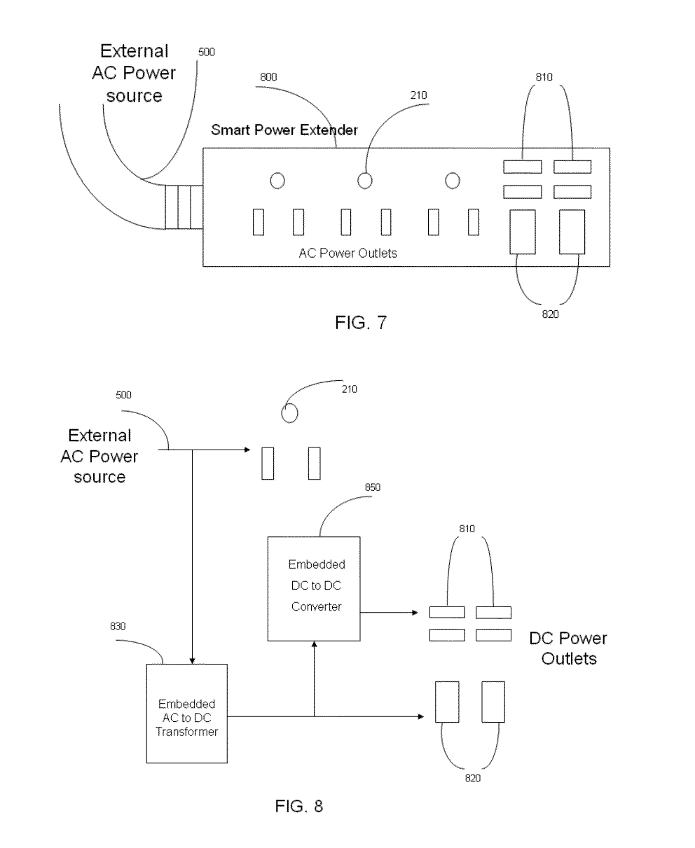

FIG. 7 illustrates a Smart Power Extender or SPE 800 powered having AC and DC power outlets in accordance with one embodiment of the present invention. In one embodiment, SPE 800 includes AC power outlets 210 and DC power outlets 810-820 wherein SPE 800 receives AC power from the external AC power source 500. While AC power outlets 210 delivers AC power, DC power outlets 810-820 are configured to deliver DC power with different voltage levels.

SPE 800 has three (3) AC power outlets, four Type A 810 DC power outlets, and two Type B 820 DC power outlets. The number of power outlets is implementation specific. Type A 810 and Type B 820 DC power outlets can be anything from 3V to 24V. The DC power output voltage levels are also implementation specific. An advantage of providing both the AC and DC power output is to save consumers from using multiple AC-to-DC transformers with a simple cable connection from the SPE to their DC powered electronic devices while at the same time providing the traditional AC power to their AC powered electronic/electrical appliances. As noted, this SPE 800 has an external AC power source 500.

FIG. 8 is a circuit block diagram illustrating circuitry inside of Smart Power Extender or SPE able to provide AC and DC power in accordance with one embodiment of the present invention. SPE illustrated in FIG. 8 includes an embedded AC to DC transformer 830 and an embedded DC to DC converter 850, wherein both transformer 830 and converter 850 are coupled to DC power outlets 810 and 820. In one embodiment, embedded AC to DC transformer 830 converts AC power from external AC power source 500 to DC power. DC power outlets 820 are able to deliver DC power supplied from transformer 830. Converter 850 is capable of dividing DC power from transformer 830 into different voltage levels which is subsequently passed to DC power outlets 810.

FIG. 8 shows circuit level of a block diagram illustrating SPE shown in FIG. 7. An external AC power source 500 is routed to the embedded AC-to-DC Transformer 830. The DC output of AC-to-DC Transformer 830 is fed to Type A 810 and Type B 820 of DC power outlets. If DC output voltage level requirement in Type B 820 is higher than the Type A 810 DC output voltage level, an embedded Control Unit with DC-to-DC converter 850 is used to step down and to provide proper voltage before reaching Type A 810 DC power outlets.

For example, when the requirement of Type A 810 is 5V DC while Type B 820 is 18V DC, then embedded AC-to-DC Transformer 830 is used to transform or convert AC power source 500 to 18V DC power directed by Control Unit with DC-to-DC converter 850, and the output of AC-to-DC Transformer 830 is directly routed to Type B 820 DC power outlets. At the same time, 18V DC is routed to the embedded Control Unit with DC-to-DC converter 850 and the resulting DC output is routed to Type A 810 power outlets such as 5V DC power. In one example, in the absence of Type B 820 DC power outlet and requirement of Type A 810 is 5V, AC-to-DC Transformer 830 transforms AC power source 500 to 5V DC and subsequently routes to 5V DC to Type A 810 power outlets without the use of embedded Control Unit with DC-to-DC converter 850.

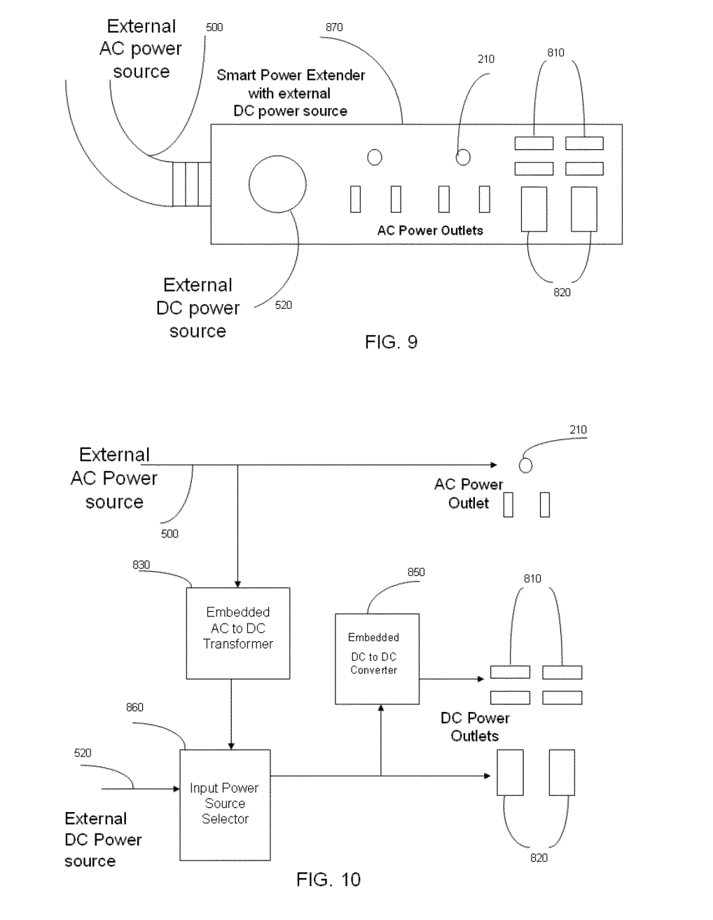

FIG. 9 illustrates a SPE connected to AC power source 500 and DC power source 520 in accordance with one embodiment of the present invention. SPE 870, in one embodiment, is able to accept power from both AC power source 500 and DC power source 520. It should be noted that AC power outlet 210 and DC power outlets 810-820 can supply different voltage levels.

Referring to FIG. 9, addition DC power source 520 is added to the design of SPE 870 equipped with external DC power source 520. In one embodiment, embedded AC-to-DC Transformer is eliminated if an actual DC power source 520 is plugged or attached for consumer requirement or governmental regulations.

FIG. 10 is a circuit block diagram illustrating circuitry inside of SPE in accordance with one embodiment of the present invention. The elements or circuits of SPE illustrated in FIG. 10 include an embedded AC to DC transformer 830, an embedded DC to DC converter 850, and an input power source selector 860. While AC power outlet 210 is coupled to AC power source 500, transformer 830 and converter 850 are coupled to DC power outlets 810 and 820. Embedded AC to DC transformer 830 converts AC power from external AC power source 500 to DC power. Input power source selector 860 is used to dynamically select proper (or adequate) power supply feeding to DC power outlets 810 or 820. DC power outlets 820 are able to deliver DC power supplied received from selector 860. For example, when DC input matches with output required at outlets 810 or 820 by one or more plugged-in systems, the input DC power can be fed directly to the plugged-in systems bypassing main circuitry of input power source selector 860. Alternatively, converter 850 is capable of dividing DC power from transformer 830 into different voltage levels which is subsequently passed to DC power outlets 810 and 820. In one aspect, outlet 820 is configured to supply various voltages in accordance with PRI.

FIG. 10 illustrates a circuit level block diagram of SPE equipped with external DC power source 870 as illustrated in FIG. 9. The operation is very similar to the way that is shown in FIG. 8 and examples as explained in the previous sections except that when an external DC power source 520 is present, embedded input power source selector 860 automatically selects DC input power from external DC power source 520. An optional Control Unit with DC-to-DC Converter 850 is used only when Type A 810 and Type B 820 power outlets co-exist having different voltage output requirement. However, when the external DC power source 520 is removed, input power source selector 860 chooses power output from embedded AC-to-DC Transformer 830 and provides DC power to Type A 810 and Type B 820 of DC power outlets. SPE, in one embodiment, provides flexibility to a user who is able to selectively choose between external AC power and external DC power as input power under certain circumstances and requirement.

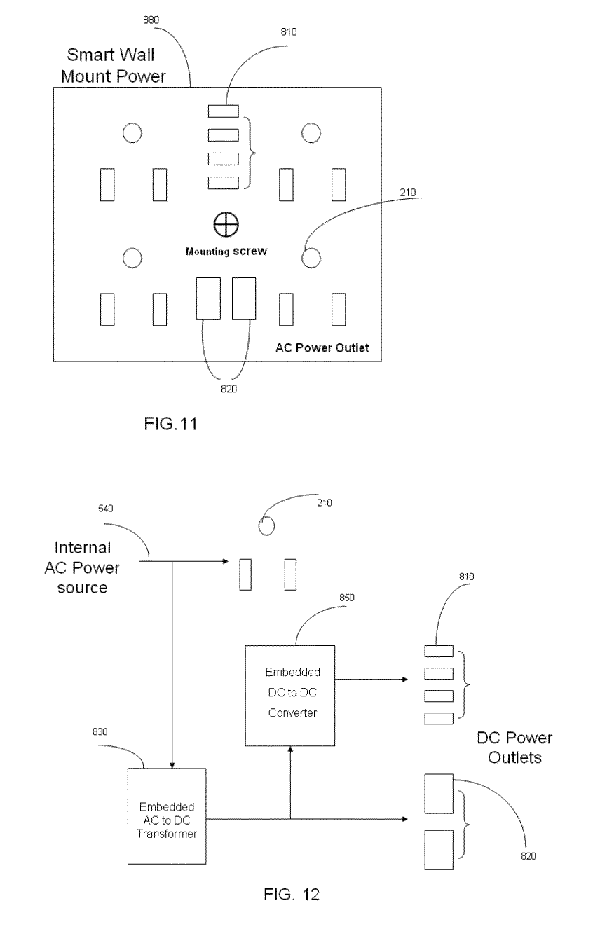

FIG. 11 illustrates a SWP 880 powered by an internal AC power source in accordance with one embodiment of the present invention. SWP 880 includes a face plate with four (4) AC power outlets 210, four Type A 810 DC power outlets, and two (2) Type B 820 DC power outlets. Type A 810 and Type B 820 DC power outlets provide DC power having a range from 3V to 24V (or up to 48V). The number of AC power outlets and DC power output voltage levels are implementation specific. A purpose or feature of providing both AC and DC power output is to save consumers from using multiple AC-to-DC transformers with a simple cable connection from SPE to DC powered electronic/electrical devices. At the same time, SWP 880 is also capable of providing AC power to AC powered electronic/electrical appliances. SWP 880 is adaptable to home and/or office electrical wiring system with AC outlets and DC outlets with different voltage levels.

Referring to FIG. 12 shows a Smart Wall-mounted Power powered by the internal AC power source only through the homes and offices electrical wiring system and through an embedded AC-to-DC transformer. An embedded DC-to-DC converter is used to provide different voltage levels to various DC power outlets.

FIG. 12 is a circuit block diagram illustrating circuitry of a SWP powered by an internal AC power source in accordance with one embodiment of the present invention. SWP 800 illustrates a circuit level block diagram similar to SWP shown in FIG. 7. An internal AC power source 540 is used to power AC power outlets 210. At the same time, internal AC power source 540 is routed to embedded AC-to-DC Transformer 830 wherein transformer 830 converts AC power to DC power which is subsequently routed to Type A 810 and Type B 820 DC power outlets. If the DC output voltage level requirement in Type B 820 is higher than Type A 810 DC output voltage level, an embedded Control Unit with DC-to-DC converter 850 is used to step down and to provide proper voltage before the power reaches to Type A 810 DC power outlets.

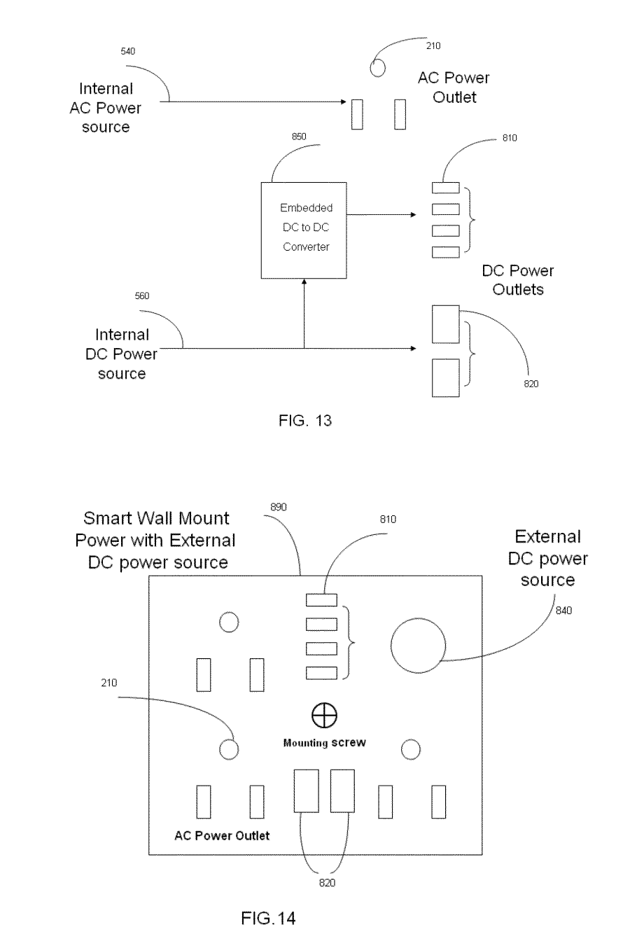

FIG. 13 is a circuit block diagram illustrating components of a SWP powered by internal AC power source and DC power source via structural electrical wiring system in accordance with one embodiment of the present invention. SWP is able to accept power from both internal AC power source 540 and DC power source 560 through a home or office electrical wiring system. AC power outlets and DC power outlets are powered by internal AC power source 540 and internal DC power source 560, respectively. An embedded DC-to-DC converter 850 is used to provide different voltage levels to various DC power outlets.

FIG. 13 shows a circuit level block diagram of SPE 800 illustrated in FIG. 7. Both AC power source 540 and DC power source 560 come from an electrical wiring network channeled from outside into homes and/or offices. Internal AC power source 540 is used to power AC power outlets 210. Internal DC power source 560 is used to power DC power outlets. If the DC output voltage level requirement at Type B 820 is higher than Type A 810 DC output voltage level, embedded Control Unit with DC-to-DC converter 850 is used to step down and to provide proper voltage at Type A 810 DC power outlets.

FIG. 14 illustrates a SWP with external DC power source and internal AC power source via electrical wiring system in accordance with one embodiment of the present invention. FIG. 14 shows an external DC power source 840 accessible to the SWP face plate 890. In addition, SWP face plate 890 further includes three (3) AC power outlets 210, four Type A 810 DC power outlets, and one Type B 820 DC power outlets. The number of power outlets is implementation specific. Type A 810 and Type B 820 DC power outlets provide DC power having a range from 3V to 24V.

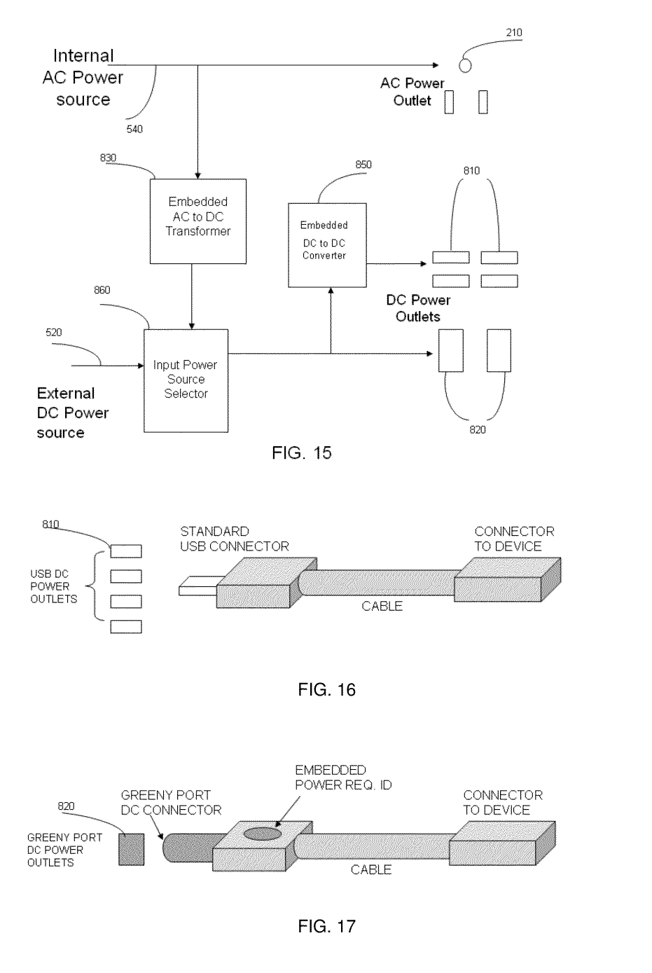

FIG. 15 shows a circuit connection inside the Smart Wall-mounted Power. The AC power outlets are powered by the internal AC power source. An input power source selector is used to select the proper power supply input to the DC power outlets dynamically depending on whether an external DC power source is available. An embedded DC-to-DC converter is used to provide different voltage levels to various DC power outlets.

FIG. 15 is a circuit block diagram illustrating circuitry inside of SWP having a power selector in accordance with one embodiment of the present invention. The diagram includes a SWP connected to an external DC power source 520 which is similar to a SWP shown in shows in FIG. 14. The operations are similar to the description shown in FIG. 12 except that when the external DC power source 520 is present, embedded input power source selector 860 chooses the power from the external DC power source 520 as the input power automatically. An optional Control Unit with DC-to-DC Converter 850 is used only when Type A 810 and Type B 820 power outlets coexist having different voltage outputs. In one embodiment, when external DC power source 520 is removed, input power source selector 850 switches the output from embedded AC-to-DC Transformer 830 as power output and routes the power to Type A 810 and Type B 820.

FIG. 16 illustrates a Smart Power Portal having a universal serial bus (“USB”) form factor in accordance with one embodiment of the present invention. USB cable includes a connector and a standard USB connector. In one embodiment, DC Power Outlet Type A 810 (likely USB type compatible) includes Smart Power Portal designs. A regular DC power cable for the connected, DC powered electrical or electronic devices. Type A 810 connectors can be configured at a fixed voltage when there is no PRI received from the connected cable or the connected device.

FIG. 17 illustrates a Greeny Port capable of coupling external to Smart Power Portal having an embedded means of PRI in accordance with one embodiment of the present invention. The Smart Power Portal includes DC Power Outlet Type B 820 (likely be called Greeny Port) and a uniquely designed DC power cable capable of connecting to electrical or electronic devices operable DC power. Type B 820 connectors is configured to function with automatic detection of the PRI and to provide proper DC power to each connected device(s). As noted on FIG. 17, an embedded PRI mechanism is built-in as part of the DC power cable which is to be connected to Type B 820 connector of Greeny Port of the Smart Power Portal. The configuration of PRI mechanisms are implementation specific. In addition, Type B 820 ports are able to detect and receive power requirement identification (PRI) at the device level from the connected electronic devices. The connected device, in one aspect, provides necessary information to Type B 820 via ports whereby proper DC power is specified in response to PRI.

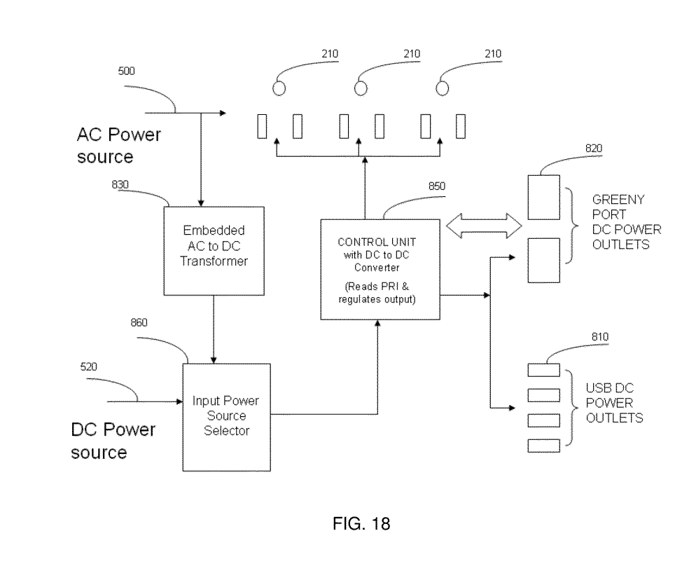

FIG. 18 is a circuit block diagram illustrating components inside of Smart Power Portal having a control unit in accordance with one embodiment of the present invention. The circuit level block diagram includes Control Unit with DC-to-DC Converter 850 which is able to (1) regulate DC power output to Type A 810 connectors; (2) read PRI and provide proper DC power in accordance with PRI to each device connected to Type B 820 port; and (3) control states of any and/or all ports with proper power characteristics in the Smart Power Portal designs.

Control Unit with DC-to-DC Converter 850, for example, can selectively switch on/off two of the three AC power ports 210 shown in FIG. 18 based on a control request. The control request may be received from external signaling such as programmed triggering, external real-time or non-real-time protocols, or PRI read from a plugged-in device that provides the information. The types and means of communication of the control protocols are implementation specific.

From the description given above, one of the ordinary skills in the art will appreciate that the design of such power extender and the wall-mounted power reduces a tremendous amount of AC-to-DC transformers required today and helps in maximizing the efficiency of global resource usage. The present design will also improve the convenience of consumers with flexible power sources and outlets that fits various circumstances and conditions without the need of having to have multiple traditional power adapters readily in hand. At the same time, such design helps to reduce the energy loss during the AC-to-DC transformation by routing directly the DC power generated from the Solar panels and other renewable green power to homes and offices.

While particular embodiments of the present invention have been shown and described, it will be obvious to those of skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. An apparatus for supplying electrical power, comprising:
a receiver configured to couple to an alternating current (“AC”) power source for drawing electricity of AC power from the AC power source;
a transformer coupled to the receiver, and able to convert at least a portion of the AC power to direct current (“DC”) power;
a DC converter coupled to the receiver, and configured to convert the DC power into a plurality of DC voltage levels; and
a Greeny port coupled to the DC converter and capable of coupling with a removable electronic device, wherein the Greeny port is capable of detecting power required to operate the removable electronic device.

2. The apparatus of claim 1, further comprising a DC power receiver coupled to the DC converter, and configured to couple to a DC power source for drawing electricity of DC power from the DC power source.

3. The apparatus of claim 2, wherein the DC converter is able to receive a first portion of DC power from the transformer and a second portion of DC power from the DC power source.

4. The apparatus of claim 1, further comprising a plurality of DC power outlets coupled to the DC converter, and configured to include a plurality of form factors capable of connecting to multiple external electronic devices for providing power supply.

5. The apparatus of claim 1, further comprising an AC power outlet coupled to the receiver, and configured to supply AC power to one or more external electronic devices requiring AC power.

6. The apparatus of claim 1, further comprising a voltage controller coupled to the Greeny port and capable of calibrating DC output voltage from the plurality of DC voltage level to match at least minimal required power level of a connected external electronic device after performing an initial power detecting process.

7. The apparatus of claim 6, wherein the voltage controller is configured to route AC power from AC power source to a plurality of AC power outlets and route DC power from DC power source to a plurality of DC power outlets.

8. The apparatus of claim 6, wherein the voltage controller is configured to convert AC power from AC power source to DC power if DC power source is not available.

9. The apparatus of claim 6, wherein the voltage controller is configured to convert DC power from DC power source to AC power if AC power source is not available.

10. The apparatus of claim 1, wherein the transformer is able to maintain a portion of the AC power channeling to at least one AC power outlet.

11. The apparatus of claim 1, wherein the DC converter is configured to provide a range of DC voltage from 1 voltage to 50 voltages.

12. The apparatus of claim 1, wherein the DC converter is configured to provide a range of DC current from 1 milli-ampere to 5 ampere.

13. The apparatus of claim 1, wherein the Greeny port detects minimal power required to operate the removable electronic device in response to power requirement identification (“PRI”) provided by the removable electronic device.

14. The apparatus of claim 13, wherein the Greeny port detects PRI from the removable electronic device via initial communication and provides a DC power level to the removable electronic device in response to the PRI.

15. A power extender structured in a power strip capable of providing AC power and DC power comprising the apparatus of claim 1.

16. A wall-mounted power bracket or faceplate capable of providing AC power and DC power comprising the apparatus of claim 1.

17. A power supply device capable of providing power, comprising:
a source connector coupled to a AC power source for receiving AC power; and
an internal control unit coupled to the source connector, and able to process power requirement information from external of the Smart Power Portal power supply, and configured to control ports and DC power levels, wherein the internal control unit further includes,
a function to detect connecting ports and enquire power requirement identification (“PRI”) from a connected external cable;
a processor to process PRI and determine DC power characteristics to be supplied to connected DC power outlets;
a function to supply pre-configured DC power to the connected DC power outlets;
a function to supply a plurality of identified DC power levels to DC power outlets in response to PRI;
a function to control states of any AC and DC outlet ports in the Smart Power Portal based upon programmed conditions and information received through communication protocols; and
a function to send and receive power consumption and control information of the Smart Power Portal to and from external devices.

18. A power supply configuration having an embedded monitoring circuitry capable of identifying and supplying required power supply to an attached device, comprising:
a DC power outlet of a Smart Power Portal configured to obtain power requirement identification (“PRI”) from a connected device and identify DC power in accordance with the PRI;
a Greeny connecting enabled cable configured to couple an electronic device with one of Smart Power Portal DC power outlets, wherein the Greeny connecting enabled cable includes a unique PRI tailored specifically for supplying power to a plurality of DC powered electronic devices having similar power requirements;
a Greeny connecting enabled connector configured to couple an electronic device with one of the Smart Power Portal DC power outlets, wherein the Greeny connecting enabled connector includes a unique PRI configured specifically for supplying power to a plurality of DC powered electronic devices with similar power requirements; and
a radio-frequency identification (“RFID”) enabled and Greeny connecting enabled label attached to a connector or cable coupling the electronic device to one of the Smart Power Portal DC power outlets, wherein the RFID enabled and Greeny connecting enabled label includes a unique PRI configured for supplying power to a plurality of DC powered electronic device with similar power requirements.

19. The power supply configuration of claim 18, wherein the DC power outlet of a Smart Power Portal further is able to provide DC power with fault protection.

20. The power supply configuration of claim 18, wherein the DC power outlet of a Smart Power Portal further is able to receive PRI via one of wireless signal, Bluetooth™ signal, radio signal, optical signal, and electrical signal.
